(19) United States
(12) Patent Application Publication
(10) Pub. No.: US 2010/0179256 A1
(43) Pub. Date: Jul. 15, 2010

(54) Highly Filled Colorant Composition For Coloring Olefinic And Also Nonolefinic Plastics

(75) Inventors: Reinhold Kling, Gersthofen (DE); Uwe Bernhardt, Bad Ems (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/377,249

(22) PCT Filed: Aug. 10, 2007
(86) PCT No.: PCT/EP07/07081

§ 371 Date: Feb. 24, 2009

(30) Foreign Application Priority Data
Aug. 12, 2006 (DE) 102006037832.6
Aug. 25, 2006 (DE) 102006039913.7

(51) Int. Cl. C09B 67/22

(52) U.S. Cl. 524/88; 524/90; 524/96; 524/174

(57) ABSTRACT

A colorant composition comprising finely distributed colorants and a plurality of polyolefin waxes, wherein a metallocene polyolefin wax having a viscosity in the rant from 3000 to 80000 mPa·s and optionally further waxes, for example polar or nonpolar non-metallocene polyolefin waxes or homo- and/or copolymers of ethylene and/or propylene are present. All polyolefin waxes together make up at least 50% by weight of the formulation and melt in the temperature range between 50 and 170° C. The inventive colorant composition has reduced dusting and is used for the production of colored plastics parts.

The present invention relates to a highly filled colorant composition which can be used to improve uniformity of dispersion of pigments in plastics, and at the same time to stabilize the plastics matrix with respect to light.

The invention also relates to the use of copolymeric, low-molecular-weight waxes for the production of supply forms in which the waxes are to a substantial extent prepared by means of metallocene catalysts and have low drop point, high transparency, and high viscosity. Use of these waxes markedly improves the dispersion of pigments, pigment loading can be increased, better compatibility with various polymers is obtained, and it is possible to omit any polymeric carrier.

Plastics are usually colored by using pigment concentrates. The pigment concentrates, prepared by the extrusion process, have pigment contents in the range from 10 to 75% by weight and comprise a polymeric carrier, and also various further additives, such as waxes and other dispersing agents, which promote the incorporation process and ensure maximum uniformity of dispersion of the pigments.

In order to provide light-stabilizing modification of the plastic simultaneously with the coloring process, the mixture can also receive additions of relatively large amounts of light stabilizers, such as UV absorbers, nickel stabilizers, or HALS products, or combinations of said products.

Stringent requirements are placed upon these pigment concentrates:

The pigments should have ideal dispersion, since inadequate dispersion of the pigments can lead to pigment agglomerates and to formation of specks in the final product, which may, for example, be a foil. Specks can also easily lead to inferior mechanical properties in the final product, which is subject to premature cracking.

The following single- or multistage processes are currently known for preparing dust-free preparations, in the form of pellets or of powder, of pigments and of dyes:

The premixes of pigment-carrier material can be prepared via cold mixing or via hot mixing. Following this, mixing can be carried out in the melt in a suitable extruder or in kneaders. This is followed by pelletization, milling, or spraying.

A cold mix is composed of suitable polymer carriers, such as polyethylene, polypropylene, or ethylene-vinyl acetate copolymer, and the like, and also of further dispersing agents, such as waxes, fatty acid derivatives, stearates, etc. The disadvantage of these mixtures is the inadequate prewetting of the pigments via the mixing process, and this is discernible in high levels of dusting.

In the hot-mixing process, the mixture comprises, as with cold mixing, carrier materials, and also waxes, but here the mixture is agglomerated by way of intensive introduction of frictional energy, giving freedom from dust and higher bulk density.

DE-A-15 44 830 discloses a pigment preparation in which the pigment particles have been encapsulated by an amorphous homo- or copolymer composed of propylene, 1-butene, and 1-hexene, or a propylene-ethylene block polymer. Filtration steps and drying steps are required when preparing the pigment preparation.

DE-A-12 39 093 describes carrier materials based on a mixture composed of an amorphous ethylene-propylene block copolymer with a crystalline polypropylene, for preparation of pigment concentrates.

DE-A-26 52 628 relates to the use of polypropylene waxes whose viscosity is from 500 to 5000 mPa·s (170° C.) and whose isotactic content is from 40 to 90%.

DE-A-195 16 387 describes how highly effective dispersion can be achieved via a dispersing agent which comprises a mixture of different polyolefin components and of specific polyacrylates.

JP-A-88/88287 describes preparations composed of pigment, lubricant, fillers, and an amorphous polyolefin.

DE-A 26 08 600 relates to pigment concentrates for the coloring of thermoplastics, comprising pigment, polyolefin wax, an ethylene-vinyl acetate copolymer, and colloidal silica.

WO 01/64800 relates to the use of polyolefin waxes synthesized by means of metallocene catalysts, as dispersing agents for pigments in a plastics matrix. The examples given describe 30% content of organic pigment.

All of the pigment preparations hitherto used in industry for coloring of polymers preferably comprise the polymer to be colored and to some extent incompatible constituents. When used in other polymers, the known pigment preparations give weaker color and less brilliance for the same pigment content, because the carrier material is less advantageous. Specific supply forms are more complicated, and cannot be prepared with high colorant concentrations equivalent to the property profile described below.

Operations for preparation of organic pigment supply forms usually involve a two-stage process with pigment content of 40% by weight or less, since the high pigment content reduces the extrudate strength of the supply forms produced. Strand pelletization is prior art for the preparation of these supply forms. One way of improving this would be to use polymers with low melt flow index MFI, this being equivalent to relatively high melt strength and therefore implying less break-off of extrudate. However, dispersion of polymers whose MFI is relatively low is poorer in the final product, and a consequence of this is discernible color differences in the form of color streaks in the final product.

The object of the present invention consisted in achieving maximum loading of organic and inorganic pigments in dust-free colorant preparations for polymer coloring, in order that the manufacture of compounded materials and the direct coloring of plastomers and elastomers can be achieved in an economically and environmentally advantageous manner using a unitary carrier system, thus giving high-quality products. The intention here is as far as possible to omit a conventional polymeric carrier, thus firstly permitting preparation of supply forms with markedly higher pigment content and secondly permitting use of the finished supply forms in significantly more polymers with different chemical constitution than hitherto, because of increasing compatibility.

The invention achieves this object via a colorant composition composed of a mixture composed of wax and polymer, which comprises a metallocene wax, i.e. a wax which is prepared in the presence of metallocenes as catalyst. The colorant composition thus prepared is compounded in a specific extrusion process to give the supply forms of the invention, but it is also possible, as an alternative, to use the mixture directly for plastics coloring.

The present invention provides a colorant composition, comprising
i) one or more finely dispersed colorants,
ii) one or more metallocene polyolefin waxes, and
iii) optionally one or more waxes selected from polar and non-polar non-metallocene polyolefin waxes, and
iv) if appropriate, one or more homo- and/or copolymers of ethylene or of propylene,
   characterized in that the amount present of the metallocene polyolefin waxes is at least 50% by weight, based on the total weight of the waxes and/or copolymers present in the colorant composition, that the melt viscosity of the metallocene polyolefin waxes, measured at a temperature of 170° C., is in the range from 3000 to 80 000 mPa·s, preferably from 3100 to 35 000 mPa·s, in particular from 3200 to 10 000 mPa·s, and that the colorant composition comprises an amount in the range from 40 to 85% by weight of one or more colorants, based on the total weight of the colorant composition.

The colorant composition of the invention features a particularly high content of colorant and of filler in the range from 40 to 85% by weight, based on the total weight of the colorant composition, and features very good compatibility with the polymers used, the result being very substantial exclusion of any impairment of the mechanical properties of the polymers used.

All of the waxy or polymeric constituents of the colorant composition of the invention melt at temperatures in the range from 50 to 170° C.

Colorant compositions preferred in the invention comprise from 40 to 85% by weight, preferably from 45 to 80% by weight, of an organic or inorganic colorant, and from 7.5 to 60% by weight, preferably from 8.5 to 55% by weight, of the metallocene polyolefin wax, based in each case on the total weight of the colorant composition.

The colorant composition preferred in the invention can also comprise from 0.1 to 30% by weight, preferably from 0.5 to 25% by weight, of functional content to improve wetting and compatibility, in the form of non-metallocene polyolefin waxes or of homo- and/or copolymers of ethylene or of propylene, and also from 0 to 50% by weight of conventional fillers or additives.

It is also possible that copolymer waxes composed of propylene and from 0.1 to 50% of ethylene, and/or from 0.1 to 50% of at least one branched or unbranched 1-alkene having from 4 to 20 carbon atoms, with a (ring/ball) drop point of from 80 to 170° C. are present in the colorant composition.

The waxes prepared in the presence of metallocene as catalyst are substantially or completely amorphous, and can also have been polar-modified, if necessary.

Suitable non-metallocene polyolefin waxes are firstly in particular ethylene-vinyl acetate copolymer waxes whose drop point is from 90 to 120° C., whose vinyl acetate content is from 1 to 30% by weight, and whose viscosity is from 50 to 3000 mPa-s, preferably from 50 to 1500 mPa-s at a temperature of 140° C., and secondly non-polar, or else polar, non-metallocene waxes whose drop point is in the range from 90 to 120° C. and whose viscosity is smaller than 30 000 mPa·s, preferably smaller than 15 000 mPa·s, at a temperature of 140° C.

Non-metallocene polyolefin waxes that can be used are homopolymers of ethylene or of higher 1-olefins having from 3 to 10 carbon atoms, or their copolymers with one another. The weight-average molar mass M_{w}of the polyolefin waxes is preferably from 1000 to 20 000 g/mol, and their number-average molar mass Mₙis from 500 to 15 000 g/mol.

Copolymers of ethylene can moreover be used advantageously as compatibilizers in the inventive colorant composition. Examples of copolymers of ethylene that can be used here are ethylene-methyl acrylate copolymers, ethylene-ethyl acrylate copolymers, ethylene-butyl acrylate copolymers, and ethylene-vinyl acetate copolymers. The comonomer content of these products is typically from 10 to 20%, and their melt index is typically from 1 to 10 g/10 min, for 190° C. and 2.16 kg. They are termed “copolymers of ethylene” in the description hereinafter.

Metallocene compounds of the formula I are used for preparation of the metallocene polyolefin waxes used according to the invention.

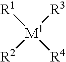

This formula also encompasses compounds of the formula Ia

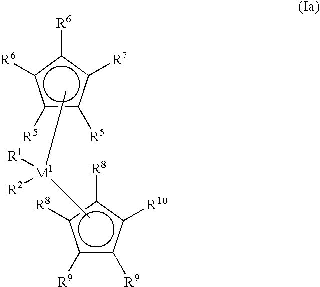

of the formula Ib

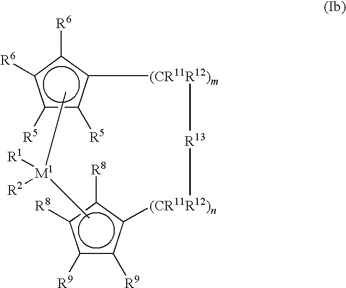

and of the formula Ic

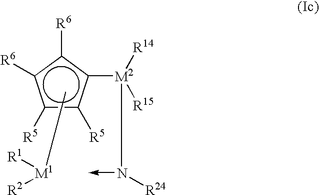

In the formulae I, Ia and Ib, M¹ is a metal of group IVb, Vb, or VIb of the Periodic Table, e.g. titanium, zirconium, hafnium, vanadium, niobium, tantalum, chromium, molybdenum, tungsten, preferably titanium, zirconium, hafnium.

R¹ and R² are identical or different and are a hydrogen atom, a C₁-C₁₀-alkyl group, preferably C₁-C₃-alkyl group, in particular methyl, a C₁-C₁₀-alkoxy group, preferably C₁-C₃-alkoxy group, a C₆-C₁₀-aryl group, preferably C₆-C₈-aryl group, a C₆-C₁₀-aryloxy group, preferably C₆-C₈-aryloxy group, a C₂-C₁₀-alkenyl group, preferably C₂-C₄-alkenyl group, a C₇-C₄₀-arylalkyl group, preferably C₇-C₁₀-arylalkyl group, a C₇-C₄₀-alkylaryl group, preferably C₇-C₁₂-alkylaryl group, a C₈-C₄₀-arylalkenyl group, preferably C₈-C₁₂-arylalkenyl group, or a halogen atom, preferably a chlorine atom.

R³ and R⁴ are identical or different and are a mono- or polynuclear hydrocarbon radical which can form a sandwich structure with the central atom M¹. R³ and R⁴ are preferably cyclopentadienyl, indenyl, tetrahydroindenyl, benzoindenyl, or fluorenyl, and the parent structures here may also bear additional substituents or may have bridging to one another. One of the radicals R³ and R⁴ may moreover be a substituted nitrogen atom, where R²⁴ is as defined for R¹⁷ and is preferably methyl, tert-butyl, or cyclohexyl.

R⁵, R⁶, R⁷, R⁸, R⁹, and R¹⁹ are identical or different and are a hydrogen atom, a halogen atom, preferably a fluorine atom, chlorine atom, or bromine atom, a C₁-C₁₀-alkyl group, preferably C₁-C₄-alkyl group, a C₆-C₁₀-aryl group, preferably C₆-C₈-aryl group, a C₁-C₁₀-alkoxy group, preferably C₁-C₃-alkoxy group, an —NR¹⁶₂—, —SR¹⁶—, —OSiR¹⁶₃—, or —PR¹⁶₂— radical, where R¹⁶ is a C₁-C₁₀-alkyl group, preferably C₁-C₃-alkyl group, or C₆-C₁₀-aryl group, preferably C₆-C₈-aryl group, or in the case of Si- or P-containing radicals, a halogen atom, preferably a chlorine atom, or any two adjacent radicals R⁵, R⁶, R⁷, R⁸, R⁹, or R¹⁰ form a ring with the carbon atoms connecting them. Particularly preferred ligands are the substituted compound structures derived from the parent structures cyclopentadienyl, indenyl, tetrahydroindenyl, benzoindenyl, or fluorenyl.

R¹³ is

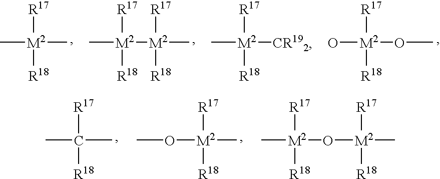

═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸, and R¹⁹ are identical or different and are a hydrogen atom, a halogen atom, preferably a fluorine atom, chlorine atom, or bromine atom, a C₁-C₃₀-alkyl group, preferably C₁-C₄-alkyl group, in particular a methyl group, a C₁-C₁₀-fluoroalkyl group, preferably CF₃ group, a C₆-C₁₀-fluoroaryl group, preferably pentafluorophenyl group, a C₆-C₁₀-aryl group, preferably C₆-C₈-aryl group, a C₁-C₁₀-alkoxy group, preferably C₁-C₄-alkoxy group, in particular a methoxy group, a C₂-C₁₀-alkenyl group, preferably C₂-C₄-alkenyl group, a C₇-C₄₀-aralkyl group, preferably C₇-C₁₀-aralkyl group, a C₈-C₄₀-arylalkenyl group, preferably C₈-C₁₂-arylalkenyl group, or a C₇-C₄₀-alkylaryl group, preferably C₇-C₁₂-alkylaryl group, or R¹⁷ and R¹⁸, or R¹⁷ and R¹⁹ form a ring in each case together with the atoms connecting them.

M² is silicon, germanium, or tin, preferably silicon and germanium. R¹³ is preferably ═CR¹⁷R¹⁸, ═SiR¹⁷R¹⁸, ═GeR¹⁷R¹⁸, —O—, —S—, ═SO—, ═PR¹⁷, or ═P(O)R¹⁷.

R¹¹ and R¹² are identical or different and are as defined for R¹⁷. m and n are identical or different and are zero, 1 or 2, preferably zero or 1, where m+n is zero, 1 or 2, preferably zero or 1.

R¹⁴ and R¹⁵ are as defined for R¹⁷ and R¹⁸.

Examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienyldibenzylzirconium,
biscyclopentadienyldimethylzirconium,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-isopropylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilyibis-1-indenylzirconium dichloride,
dimethylsilylbis-1-indenyldimethylzirconium,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
   and also each of the alkyl or aryl derivatives of these metallocene dichlorides.

Suitable cocatalysts are used to activate the single-center catalyst systems. Suitable cocatalysts for metallocenes of the formula I are organoaluminum compounds, in particular aluminoxanes, or else aluminum-free systems, such as R²⁰ₓNH₄₋ₓBR²¹₄, R²⁰ₓPH₄₋ₓBR²¹₄, R²⁰₃CBR²¹₄ or BR²¹₃. x in these formulae is a number from 1 to 4, and the radicals R²⁰ are identical or different, preferably identical, and are C₁-C₁₀-alkyl or C₆-C₁₈-aryl, or two radicals R²⁰ form a ring together with the atom connecting them, and the radicals R²¹ are identical or different, preferably identical, and are C₆-C₁₈-aryl, which may have substitution by alkyl, by haloalkyl, or by fluorine. In particular, R²⁰ is ethyl, propyl, butyl, or phenyl, and R²¹ is phenyl, pentafluorophenyl, 3,5-bistrifluoromethylphenyl, mesityl, xylyl, or tolyl.

A third component is also often required in order to maintain protection from polar catalyst poisons. Organoaluminum compounds are suitable for this purpose, examples being triethylaluminum, tributylaluminum, and others, and also mixtures.

As a function of the process, it is also possible to use supported single-center catalysts. Preference is given to catalyst systems in which the residual contents of support material and cocatalyst do not exceed a concentration of 100 ppm in the product.

The colorant compositions of the invention can also comprise auxiliaries, such as UV absorbers, nickel stabilizers, sterically hindered amines (HALS products), and combinations thereof. This applies to all of the products given on pages 114 to 136 of Additiv Handbook [Additives Handbook] edition No. 5 (2000 edition).

Further auxiliaries that can be used are antistatic agents, oleamide, glycerol fatty acid partial esters, stearates, PVC plasticizers, polyglycerols, slip agents, and antioxidants, and fillers that can be used if necessary are zeolites, silica, montmorillonites, bentonites, and silicates, such as aluminum silicates, sodium silicate, and calcium silicates.

Colorants that can be used are organic and inorganic dyes and pigments. Organic dyes and pigments preferably used are azo pigments or disazo pigments, laked azo pigments or laked disazo pigments, or polycyclic pigments, preferably phthalocyanine pigments, quinacridone pigments, perylene pigments, dioxazine pigments, anthraquinone pigments, thioindigo pigments, diaryl pigments, or quinophthalone pigments.

Inorganic dyes and pigments for pigmentation are suitable metal oxides, mixed oxides, aluminum sulfates, chromates, metal powders, pearl-luster pigments (mica), luminescent colors, titanium oxides, cadmium-lead pigments, preferably iron oxides, carbon black, silicates, nickel titanates, cobalt pigments, or chromium oxides.

The required content of metallocene waxes and, if appropriate, of other polyolefin waxes, or of homo- and/or copolymers of ethylene and/or of propylene depends on the surface structure and particle size of the colorants used, and is preferably intended to be selected appropriately therefor.

When organic dyes and pigments are used, a particularly advantageous colorant composition comprises from 40 to 85% by weight, in particular from 45 to 80% by weight, of organic pigment, and from 15 to 60% by weight, preferably from 20 to 55% by weight, of wax and, if appropriate, homo- and/or copolymers of ethylene or of propylene, where the composition is in particular as follows: from 7.5 to 42.5% by weight of metallocene polyolefin wax, from 0.1 to 20% by weight of ethylene-vinyl acetate wax, from 0.5 to 20% by weight of oxidized wax, or from 0.5 to 20% by weight of homo- and/or copolymers of ethylene and/or of propylene, and also, if appropriate, other fillers or additives, in amounts of from 0 to 50% by weight.

When inorganic pigments are used, a particularly advantageous colorant composition comprises from 60 to 85% by weight of inorganic pigment and from 15 to 40% by weight of wax, and, if appropriate, homo- and/or copolymers of ethylene and/or of propylene, where the composition is in particular as follows: from 7.5 to 30% by weight of metallocene polyolefin wax and from 7.5 to 20% by weight of other olefin waxes or homo- and/or copolymers of ethylene and/or of propylene, and also from 0.1 to 50% by weight of additives.

Mixing specifications for carbon blacks are advantageously as for organic formulations, in order to obtain fully dispersed preparations.

When the colorant composition is prepared according to the invention, premixing of the individual components is an important precondition during production of the product and can take place at room temperature in a suitable mixing apparatus. In the event that the mix is to be used in the form of dust-free powder mixture, a mixing phase using relatively high mixing energy follows, and it is advantageous here to heat in a first phase up to about 15 K below the softening point of the metallocene polyolefin wax and in a second phase up to about 5 K below the softening point of the metallocene wax. The duration of the first phase is about 3 to 10 min, preferably 5 to 7 min, and the duration of the second phase is about 1 to 5 min, preferably 2 to 3 min. A cooling-mixing process follows the final mixing phase, cooling the colorant composition to about 30° C. The duration of this procedure is normally 3 to 15 min, preferably 5 to 10 minutes.

The heat energy can be introduced by way of friction during mixing, or by way of separate heating of the mixing trough, or by way of both methods. Pre-conditioning to about 25° C. is considered advantageous. Higher starting temperatures for hot mixing lead to clumping of the carrier and to formation of deposits on the base of the vessel. It is likewise advantageous to cool the mixing trough after the final mixing phase to the initial temperature.

In the cooling-mixing process which follows, up to 0.5% by weight of powder-flow aid, based on the entire mixture, can be added in order to improve flowability, the aim being to achieve grain size of from 0.05 to 3 mm in a dust-free powder mixture. If the handling form is not particularly important in subsequent processes, e.g. if the mixture is used in a further intensive mixing process, the preparation of supply forms can be omitted.

When the masterbatch is prepared in a corotating twin-screw system, it is advantageous to operate with a screw structure appropriately selected for the high wax content. The temperature profile is preferably lower than hitherto stated in the prior art. Underwater pelletization is advantageously used for preparation of the supply forms.

The use of these preparations markedly improves pelletizability at these pigment loadings, not only for die-face pelletization systems but also for strand-pelletization systems.

When preparing the colorant composition of the invention, it is also advantageous to operate with an initial mixing process. First, a mixture is prepared from colorant and wax and/or homo- and/or copolymers of ethylene and/or of propylene. The mixing process uses appropriate mixing technology. However, preparation of mixtures can be omitted if the individual components of a mix are introduced directly to the extrusion plant. However, in most cases that implies loss of quality in the final product, and industry therefore uses this method only for suitable pigments. Said mixture is then introduced by means of a suitable metering apparatus to an extrusion plant. This is generally a single- or twin-screw extruder, but continuous kneaders and batch kneaders are also used. This is followed by pelletization by way of a strand-pelletization system or die-face pelletization system, another possible method being spraying.

Individualized color shades are produced by blending monopreparations in a second extrusion pass, with one another or simply with polymer. A disadvantageous factor hitherto in arriving at individualized color shades has been the high consumption of monomasterbatches. Another factor increasing production costs has been the second extrusion process, and indeed in some cases a third extrusion process. Use of the inventive colorant compositions has eliminated these disadvantages.

The inventive colorant compositions can also be used to give compounded materials, or else for the direct coloring of plastics. Compounded materials are mixtures of polymers with abovementioned additives, fillers, and/or colorants.

Surprisingly, the colorant composition of the invention permits coloring of a very wide variety of polymers, such as polyolefins, polyvinyl chloride (PVC), ethylene-vinyl acetate copolymers (EVA), styrene-acrylonitrile copolymers (SAN), rigid and flexible polyvinyl chloride (PVC), polyethylene glycol terephthalate (PET), polybutylene glycol terephthalate (PBT) and their copolyesters, acrylonitrile-butadiene-styrene copolymers (ABS), polycarbonate (PC), polyethylene waxes, polypropylene waxes, amide waxes, hydrocarbon resins, montan waxes, aliphatic waxes, butyl and other rubber, paraffin and bitumen, and also some specialty polymers.

In applications in plastics, the colorant composition of the invention is used like previous mixtures and other known supply forms. It is possible to omit the conventional hot mixing of the entire formulation, frequently used in the case of organic pigments to improve wetting of the pigments.

Each of the following inventive examples uses a metallocene wax mixture prepared from the following waxes: metallocene PP (polypropylene) wax, ethylene-vinyl acetate wax and polar and, respectively, non-polar, non-metallocene PE (polyethylene) waxes and copolymers of ethylene where the materials have the following parameters (see below). The products are used in fine-grain form.

The polyolefins a) and b) listed in table 1 and used in the invention were prepared via copolymerization of propylene with ethylene with the metallocene catalyst dimethylsilylbisindenylzirconium dichloride, by the process given in EP 0 384 264 (general specification, examples 1-16). The various softening points and viscosities were obtained by varying ethylene use and polymerization temperature.

The melt viscosities to DIN 53019 here were determined in mPa·s using a rotary viscometer, the drop points to DIN 51801/2 were determined using

Ubbelohde drop point equipment, and the ring-and-ball softening points were determined to DIN EN 1427. Density is determined to ISO 1183 in g/cm³, and molar mass is determined by means of gel permeation chromatography.

TABLE 1
Metallocene waxes used

| | a) | b) |
|---|---|---|
| Softening/drop point (° C.) | 93¹⁾ | 102¹⁾ |
| Viscosity at 170° C. (mPa · s) | 7900 | 9800 |

¹⁾drop point

TABLE 2
Ethylene-vinyl acetate copolymer (EVA) wax:

| Drop point | Viscosity at | Vinyl acetate | Density |
|---|---|---|---|
| [° C.] | 140° C. [mPa · s] | content | [g/cm³] |
| 97 | 350 | 10-12% | 0.92 |

TABLE 3
Oxidized PE wax a) or non-polar PE wax b):

| | Drop point | Viscosity at | Acid number | Density |
|---|---|---|---|---|
| | [° C.] | 120° C. [mPa · s] | [mg KOH/g] | [g/cm³] |
| a) | about 120 | about 3000 | 17 | 0.92 |
| b) | about 118 | about 650 | 0 | 0.92 |

TABLE 4
Copolymer of ethylene

| Softening | Melting | | Ethyl acrylate | |
|---|---|---|---|---|
| point | point | MFR | comonomer | Density |
| [° C.] | [° C.] | 190° C./2.16 kg | % | [g/cm³] |
| 50-60 | 85-98 | 5-10 [g/10 min] | about 15-20 | about 0.94 |

The materials are used in fine-grain form (sprayed or ground).

The inventive dye compositions were prepared as described below:

As mixture for extrusion:

Mixer: Henschel mixer, capacity 5 liters
Mix: corresponding to the examples listed below
Premixing: batch for about 4 to 6 min. at 700 rpm

Extrusion then followed in a corotating twin-screw system with downstream underwater die-face pelletization or in a strand pelletizer.

Pellet diameter from 0.8 to 2 mm.

Or for use in the form of dust-free mixtures:

Mixer: Heating-cooling combination mixer, capacity 5 liters

Mix: corresponding to the examples listed below

Premixing: batch for about 2 min. at 350 rpm

### Mixing Stage 1) and 2) and Cooling Phase

| | | |
|---|---|---|
| 1st phase: | 3100 rpm | T = from 50° C. to 60° C. |
| Mixing time: | about 5 min to 7 min | |
| 2nd phase: | 1500 rpm | T = from 65° C. to 85° C. |

| | |
|---|---|
| Mixing time: | about 2 min to 3 min |
| Mixing with | to from 20 to 30° C. |
| cooling: | |
| Mixing time: | from 5 min to 10 min at 360 rpm |

Energy was introduced exclusively by way of friction. The average grain size of the resultant mixture was smaller than 1 mm.

### PREPARATION EXAMPLES

In the examples below, the following colorant compositions were prepared by processes described above. The metallocene wax used in each case comprised one of the waxes from table 1:
1) 50% by weight of C.I. Pigment Blue 15:1 (C.I. no. 74 160 Heuco blue 515303),
15% by weight of non-polar PE wax, and
35% by weight of metallocene PP wax b)
2) 50% by weight of C.I. Pigment Blue 15:1 (C.I. no. 74 160 Heuco blue 515303),
15% by weight of EVA wax, and
35% by weight of metallocene PP wax a)
3) 65% by weight of C.I. Pigment Blue 15:1 (C.I. no. 74 160 Heuco blue 515303),
5% by weight of EVA wax, and
30% by weight of metallocene PP wax a)
4) 55% by weight of C.I. Pigment Blue 15:1 (C.I. no. 74 160 Heuco blue 515303),
7.5% by weight of EVA wax, and
7.5% by weight of oxid. PE wax, and
30% by weight of metallocene PP wax b)
5) 50% by weight of C.I. Pigment Red 122 (C.I. no. 73 915),
7.5% by weight of EVA wax, and
7.5% by weight of oxid. PE wax, and
35% by weight of metallocene PP wax a)
6) 50% by weight of C.I. Pigment Red 122 (C.I. no. 73 915),
12.5% by weight of EVA wax, and
2.5% by weight of oxid. PE wax, and
35% by weight of metallocene PP wax b)
7) 70% by weight of C.I. Pigment Brown (C.I. no. 77500),
7.5% by weight of copolymer of ethylene
7.5% by weight of oxid. PE wax, and
15% by weight of metallocene PP wax a)
8) 70% by weight of C.I. Pigment Brown 29 (C.I. no. 77500),
10% by weight of oxid. PE wax, and
20% by weight of metallocene PP wax a)
9) 70% by weight of Pigment Brown 25 (C.I. no. 12510),
7.5% by weight of copolymer of ethylene
7.5% by weight of oxid. PE wax, and
15% by weight of metallocene PP wax a)
10) 70% by weight of Pigment Brown 25 (C.I. no. 12510),
10% by weight of oxid. PE wax, and
20% by weight of metallocene PP wax a)
11) 60% by weight of Pigment Red 48:3 (C.I. no. 15865:3),
25% by weight of metallocene PP wax a)
15% by weight of non-polar PE wax

### APPLICATION EXAMPLES

The colorant compositions of Preparation Examples 1 to 11 were used directly in the form of masterbatch or in the form of powder for coloring of plastics. They can be used for the coloring of various polymers with pigment.

The following plastics were used:
1) acrylonitrile-butadiene-styrene copolymer (ABS);
2) ethylene-vinyl acetate copolymer (EVA);
3) polyester: polyethylene terephthalate (PET), polybutylene terephthalate (PBT);
4) polyethylene (HDPE);
5) polypropylene (PP);
6) styrene-acrylonitrile copolymers (SAN);
7) polystyrene (PS);
8) polycarbonate (PC)
9) rigid/flexible polyvinyl chloride (PVC)

Tests were carried out for color strength (ST 1/3), filter value (in which connection please see table 5), foil quality, and also fundamental mechanical properties. Very good dispersion qualities were achieved, and foil quality was also assessed as very good, this being a feature characteristic of good random pigment distribution. There was no significant resultant impairment of the mechanical properties of the colored polymers. Indeed, improvements were sometimes found. The properties tested here on the plastics respectively colored with an amount of 1.5 and 0.5% of supply forms, were tensile strength, tensile strain, ultimate tensile strength, and tensile strain at break. The comparative values were provided by the straight polymers without addition of supply forms or pigment.

TABLE 5
Filter values

| | 14 μm filter |
|---|---|
| Formulation | value |
| Example 11: | |
| 60% by weight of Pigment Red 48:3 (C.I. no. 15865:3) | 0.5 bar |
| 25% by weight of metallocene PP wax a) | |
| 15% by weight of non-polar PE wax | |
| Example 10: | |
| 70% by weight of Pigment Brown 25 (C.I. no. 12510) | 0.5 bar |
| 10% by weight of PE wax, and | |
| 20% by weight of metallocene PP wax a) | |
| Example 8: | |
| 70% by weight of C.I. Pigment Brown 29 (C.I. no. 77500) | 0.26 bar |
| 10% by weight of oxid. PE wax, and | |
| 20% by weight of metallocene PP wax a) | |

The particularly low filter values are evidence that the supply forms of the invention give very homogeneous dispersion of the additives within the polymer matrix, and that there is no occurrence of agglomerates or of other inhomogeneous features which would immediately cause blockage of the filters and an increase in the filter value.

1. A colorant composition, comprising
i) one or more finely dispersed colorants,
ii) one or more metallocene polyolefin waxes, and
iii) optionally one or more waxes selected from polar and non-polar polyolefin waxes, and
iv) optionally, one or more homo-polymers of ethylene, copolymers of ethylene, homo-polymers of propylene, copolymers of propylene or a mixture thereof,
wherein the one or more metallocene polyolefin waxes are present in at least 50% by weight, based on the total weight of the waxes, copolymers or both present in the colorant composition, wherein the melt viscosity of the one or more metallocene polyolefin waxes, measured at a temperature of 170° C., is in the range from 3000 to 80 000 mPa·s, and that the colorant composition comprises an amount in the range from 40 to 85% by weight of the one or more colorants, based on the total weight of the colorant composition.

2. The colorant composition as claimed in claim 1, wherein in that the waxes or copolymers of ethylene of components ii), iii), and iv) melt at temperatures in the range from 50 to 170° C.

3. The colorant composition as claimed in claim 1, wherein the drop point of the one or more metallocene polyolefin waxes is from 80 to 170° C.

4. The colorant composition as claimed in claim 1, comprising from 7.5 to 60% by weight, preferably from 8.5 to 55% by weight, of the one or more metallocene polyolefin waxes, up to 30% by weight, of the one or more non-metallocene waxes or the one or more homo-polymers of ethylene, copolymers of ethylene, homo-polymers of propylene, copolymers of propylene or mixture thereof, from 40 to 85% by weight, of the one or more colorants, and from 0 to 50% by weight of fillers or additives, based in each case on the total weight of the colorant composition.

5. The colorant composition as claimed in claim 1, wherein the one or more colorants are inorganic dyes or pigments and organic dyes or pigments.

6. The colorant composition as claimed in claim 1, wherein the one or more colorants are inorganic dyes or pigments, selected from the materials suitable for pigmentation, wherein the materials suitable for pigmentation are selected from the group consisting of: metal oxides, mixed oxides, aluminum sulfates, chromates, metal powders, pearl-luster pigments (mica), luminescent colors, titanium oxides, cadmium-lead pigments, iron oxides, carbon black, silicates, nickel titanates, cobalt pigments, and chromium oxides.

7. The colorant composition as claimed in claim 6, comprising from 7.5 to 30% by weight, of the one or more metallocene polyolefin waxes, wherein the one or more metallocene polyolefin waxes is a polypropylene metallocene wax, from 7.5 to 20% by weight of the one or more non-metallocene waxes or the one or more homo-polymers of ethylene, copolymers of ethylene, homo-polymers of propylene, copolymers of propylene or mixture thereof, from 60 to 85% by weight, of one or more inorganic pigments, and from 0.1 to 50% by weight of fillers or additives.

8. The colorant composition as claimed in claim 1, wherein the one or more colorants are one or more organic dyes or pigments selected from the group consisting of azo pigments, disazo pigments, laked azo pigments, laked disazo pigments, polycyclic pigments, phthalocyanine pigments, quinacridone pigments, perylene pigments, dioxazine pigments, anthraquinone pigments, thioindigo pigments, diaryl pigments and quinophthalone pigments.

9. The colorant composition as claimed in claim 8, comprising from 7.5 to 42.5% by weight of the one or more metallocene polyolefin waxes, wherein the one or more metallocene polyolefin waxes is a polypropylene metallocene wax, from 0.1 to 30% by weight of the one or more non-metallocene waxes or the one or more homo-polymers of ethylene, copolymers of ethylene, homo-polymers of propylene, copolymers of propylene or mixture thereof, from 30 to 75% by weight of one or more organic pigments, and from 0 to 50% by weight of conventional fillers or additives.

10. The colorant composition as claimed in claim 1, further comprising at least one additive, wherein the at least on additive is selected from the group consisting of light stabilizers, UV absorbers, nickel stabilizers, HALS products, or a combination thereof.

11. The colorant composition as claimed in claim 1, wherein the one or more non-metallocene polyolefin waxes have a drop point below 120° C. and whose viscosity is smaller than 30 000 mPa·s (measured at 140° C.) and wherein the one or more non-metallocene polyolefin waxes are selected from the group consisting of EVA waxes and oxidized waxes.

12. The colorant composition as claimed in claim 1, wherein the colorant composition is compatible with polymers and mixtures of polymers.

13. A process for preparation of a colorant composition as claimed in claim 1, comprising the steps of
heating, via mechanical mixing, a mixture composed of the one or more colorants and the one or more metallocene polyolefin waxes to a temperature of from 15 to 5 K below the softening point of the one or more metallocene polyolefin waxes to form a homogenized mixture and cooling the homogenized mixture to a temperature of from 10 to 30° C.

14. The process as claimed in claim 13, wherein the heating step occurs at a temperature in the range from 60 to 260° C.

15. The process as claimed in claim 13, wherein the heating step occurs in an extruder, using a corotating twin-screw system.

16. A supply form for the production of colored plastics parts comprising a colorant composition as claimed in claim 1.

17. A light-stabilizing modifier plastics comprising the colorant composition as claimed in claim 1.

18. The colorant composition as claimed in claim 1, wherein the melt viscosity of the one or more metallocene polyolefin waxes, measured at a temperature of 170° C., is in the range from 3100 to 35 000 mPa·s.

19. The colorant composition as claimed in claim 1, wherein the melt viscosity of the one or more metallocene polyolefin waxes, measured at a temperature of 170° C., is in the range from 3200 to 10 000 mPa·s.

20. The colorant composition as claimed in claim 1, comprising from 8.5 to 55% by weight, of the one or more metallocene polyolefin waxes, from 0.5 to 25% by weight, of the one or more non-metallocene waxes or the one or more homo-polymers of ethylene, copolymers of ethylene, homo-polymers of propylene, copolymers of propylene or mixture thereof, from 45 to 80% by weight, of the one or more colorants, and from 0 to 50% by weight of fillers or additives, based in each case on the total weight of the colorant composition.

21. The colorant composition as claimed in claim 6, comprising from 12.5 to 20.5% by weight, of the one or more metallocene polyolefin waxes, wherein the one or more metallocene polyolefin waxes is a polypropylene metallocene wax, from 7.5 to 20% by weight of the one or more non-metallocene waxes or the one or more homo-polymers of ethylene, copolymers of ethylene, homo-polymers of propylene, copolymers of propylene or mixture thereof, from 70 to 85% by weight, of one or more inorganic pigments, and from 0.1 to 50% by weight of fillers or additives.

22. The colorant composition as claimed in claim 1, wherein the colorant composition is compatible with PE; PP; EVA; PBT; PET; SAN; PS; ABS; PC, PVC; rubber, and mixtures thereof.

23. A process for preparation of a colorant composition as claimed in claim 1, comprising the step of mixing the individual components of the colorant composition cold.

24. The process as claimed in claim 13, wherein the heating step occurs at a temperature in the range from 80 to 220° C.
